(19) United States
(12) Patent Application Publication
(10) Pub. No.: US 2023/0033727 A1
(43) Pub. Date: Feb. 2, 2023

(54) SYSTEMS AND METHODS FOR PROVIDING A LIVE INFORMATION FEED DURING A COMMUNICATION SESSION

(71) Applicant: Avaya Management L.P., Durham, NC (US)

(72) Inventors: Harshal Ramesh Gawande, Pune (IN); Ghanshyam Asaram Baheti, Pune (IN); Ajay Jagdish Talreja, Pune (IN)

(21) Appl. No.: 17/387,680

(22) Filed: Jul. 28, 2021

(51) Int. Cl. H04L 12/58

(52) U.S. Cl. CPC H04L 51/046; H04L 51/10

(57) ABSTRACT

Systems and methods of providing data to users during a communication session are disclosed. Systems and methods of the present disclosure include receiving text, audio, image, video, and/or other data from one or more user devices participating in a communication session, identifying a topic of discussion based on the received data, determining one or more data sources to search based on the identified topic, performing a data search based on the identified topic, generating a results message, and displaying the results message to user devices participating in the communication session.

### FIELD

The disclosure relates generally to communication applications and particularly to systems and methods of assisting users with relevant information in a communication session in a user-friendly manner.

### BACKGROUND

As electronic user devices such as smart phones, tablets, personal computers, etc., become more commonplace, more and more communication between people occurs via text communication applications and audio/video communication applications such Avaya Spaces.

Communication over the Internet has enabled real-time spread of information. A single communication session may comprise an endless number of text messages, audio recordings, images, and GIFs, alongside a real-time audio/video communication between multiple users. While real-time communication between team members is a highly efficient and user-friendly method of communication, it does not provide the same opportunities to users as does slower communication such as email.

Virtual meetings, even though over the Internet, limit users from performing research in real-time. During live discussion of an online conference meeting, multiple topics are often discussed and there may not be enough details available related to those topics. It is often difficult for meeting participant to go outside of dashboard window, search through such relevant information and present that in live conversations of the meeting. Additionally, performing manual research to find relevant information may not result in accurate or correct information due to limitations of research time, expertise, and the scope of the data sources.

What is needed is a way for a user to achieve the benefit of research in real-time during a communication session without requiring the user to perform any action, for example by choosing to manually perform the research, closing the current window, turning his/her attention away from the communication session, performing research, finding results, and sharing results with others.

### BRIEF DESCRIPTION OF THE DRAWINGS

FIG. 1 is a block diagram of a first illustrative system for implementing a communication session in accordance with one or more embodiments of the present disclosure;

FIG. 2A is a block diagram of a user device system for executing a communication session in accordance with one or more embodiments of the present disclosure;

FIG. 2B is a block diagram of a server for executing a communication session in accordance with one or more embodiments of the present disclosure;

FIG. 3 is a flow diagram of an interchange of data in accordance with one or more embodiments of the present disclosure;

FIG. 4 is an illustration of a user interface in accordance with one or more embodiments of the present disclosure;

FIG. 5 is an illustration of a user interface in accordance with one or more embodiments of the present disclosure;

FIG. 6 is an illustration of a user interface in accordance with one or more embodiments of the present disclosure; and

FIG. 7 is a flow diagram of a process in accordance with one or more embodiments of the present disclosure.

### DETAILED DESCRIPTION

The above discussed issues with contemporary communication applications and other needs are addressed by the various embodiments and configurations of the present disclosure. As described herein, a research assistant application may be provided in conjunction with a communication application. By interacting in a communication session in which a research assistant application is monitoring the conversation, users may be enabled to view information tailored to the conversation and be provided with the results of research performed in response to the topics discussed by the users of the communication session. A research assistant application may be configured to monitor audio, text, and imagery generated by users participating in a communication session, perform research based on the audio, text, and imagery generating in the communication session, and present results of the research to the users in a user-friendly manner in real-time, such that the users may gain the benefit of the research without being required to explicitly request or perform the research. Such a system as described herein provides a rich experience to the user.

The phrases “at least one,” “one or more,” “or,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B, and C together.

The term “a” or “an” entity refers to one or more of that entity. As such, the terms “a,” “an,” “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Any combination of one or more computer readable medium(s) may be utilized. The computer readable medium may be a computer readable signal medium or a computer readable storage medium.

A computer-readable storage medium may be, for example, but should not be considered limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer-readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

The terms “determine,” “calculate,” and “compute,” and variations thereof, as used herein, are used interchangeably, and include any type of methodology, process, mathematical operation, or technique.

The term “means” as used herein shall be given its broadest possible interpretation in accordance with 35 U.S.C. § 112(f) and/or § 112, Paragraph 6. Accordingly, a claim incorporating the term “means” shall cover all structures, materials, or acts set forth herein, and all of the equivalents thereof. Further, the structures, materials or acts and the equivalents thereof shall include all those described in the summary, brief description of the drawings, detailed description, abstract, and claims themselves.

The preceding is a simplified summary to provide an understanding of some aspects of the disclosure. This summary is neither an extensive nor exhaustive overview of the disclosure and its various embodiments. It is intended neither to identify key or critical elements of the disclosure nor to delineate the scope of the disclosure but to present selected concepts of the disclosure in a simplified form as an introduction to the more detailed description presented below. As will be appreciated, other embodiments of the disclosure are possible utilizing, alone or in combination, one or more of the features set forth above or described in detail below. Also, while the disclosure is presented in terms of exemplary embodiments, it should be appreciated that individual aspects of the disclosure can be separately claimed.

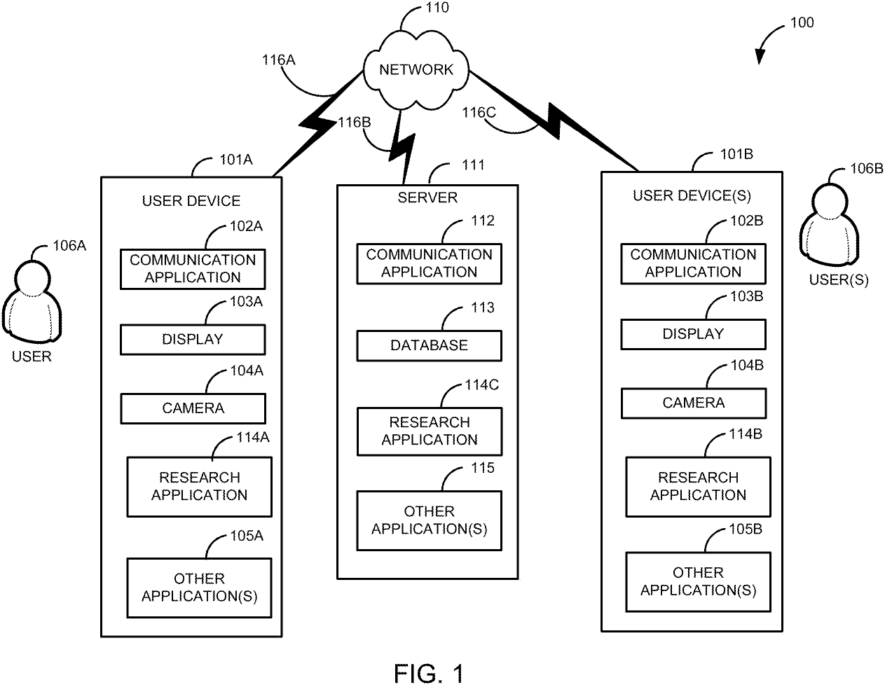

FIG. 1 is a block diagram of a first illustrative system 100 for a communication session between one or more users in accordance with one or more of the embodiments described herein. The first illustrative system 100 comprises user communication devices 101A, 101B and a network 110. In addition, users 106A-106B are also shown.

The user communication devices 101A, 101B can be or may include any user device that can communicate on the network 110, such as a Personal Computer (“PC”), a video phone, a video conferencing system, a cellular telephone, a Personal Digital Assistant (“PDA”), a tablet device, a notebook device, a smartphone, and/or the like. The user communication devices 101A, 101B are devices used as endpoints for a communication session. Although only two user communication devices 101A, 101B are shown for convenience in FIG. 1, any number of user communication devices 101 may be connected to the network 110 for establishing a communication session.

The user communication devices 101A, 101B further comprise communication applications 102A, 102B, displays 103A, 103B, and cameras 104A, 104B. It should be appreciated that, in some embodiments, user devices may lack cameras 104A, 104B. Also, while not shown for convenience, the user communication devices 101A, 101B typically comprise other elements, such as a microprocessor, a microphone, a browser, other applications, and/or the like.

In addition, the user communication devices 101A, 101B may also comprise other application(s) 105A, 105B. The other application(s) 105A can be any application, such as, a slide presentation application, a document editor application, a document display application, a graphical editing application, a calculator, an email application, a spreadsheet, a multimedia application, a gaming application, and/or the like. The communication applications 102A, 102B can be or may include any hardware/software that can manage a communication session that is displayed to the users 106A, 106B. For example, the communication applications 102A, 102B can be used to establish and display a communication session.

The displays 103A, 103B can be or may include any hardware display/projection system that can display an image of a video conference, such as a LED display, a plasma display, a projector, a liquid crystal display, a cathode ray tube, and/or the like. The displays 103A-103B can be used to display user interfaces as part of communication applications 102A, 102B.

As described herein, a user device 102A, 102B may execute an application such as a research assistant application 114A, 114B. Such a research assistant application 114C may also or alternatively be executed by a server. As discussed in greater detail below, a research assistant application 114A, 114B, 114C may enable a user of a user device 102A, 102B to be automatically presented with data relating to a topic discussed during a communication session as discussed herein.

The user communication devices 101A, 101B may also comprise one or more other application(s) 105A, 105B. The other application(s) 105A, 105B may work with the communication applications 102A, 102B.

The network 110 can be or may include any collection of communication equipment that can send and receive electronic communications, such as the Internet, a Wide Area Network (WAN), a Local Area Network (LAN), a Voice over IP Network (VoIP), the Public Switched Telephone Network (PSTN), a packet switched network, a circuit switched network, a cellular network, a combination of these, and the like. The network 110 can use a variety of electronic protocols, such as Ethernet, Internet Protocol (IP), Session Initiation Protocol (SIP), H.323, video protocol, video protocols, Integrated Services Digital Network (ISDN), and the like. Thus, the network 110 is an electronic communication network configured to carry messages via packets and/or circuit switched communications.

The network may be used by the user devices 101A, 101B, and a server 111 to carry out communication. During a communication session, data 116A may be sent and/or received via user device 101A, data 116B may be sent and/or received via server 111, and data 116C may be sent and/or received via user device 101B.

The server 111 may comprise any type of computer device that can communicate on the network 110, such as a server, a Personal Computer (“PC”), a video phone, a video conferencing system, a cellular telephone, a Personal Digital Assistant (“PDA”), a tablet device, a notebook device, a smartphone, and/or the like. Although only one server 111 is shown for convenience in FIG. 1, any number of servers 111 may be connected to the network 110 for establishing a communication session.

The server 111 may further comprise a communication application 112, database(s) 113, research assistant application 114C, other application(s) 115, and, while not shown for convenience, other elements such as a microprocessor, a microphone, a browser application, and/or the like. In some embodiments, a research assistant application 114 may comprise a voice processing system, a text analysis system, a natural language processing system, or other components. The research assistant application 114 may be configured to execute one or more components based on machine learning and/or natural language processing (“NLP”). In some embodiments, machine learning and/or NLP algorithms may be executed by a server or another computer system to carry out the work of analyzing voices, identifying speakers, converting voice to text, analyzing queries, analyzing transcripts, detecting topics of conversation, detecting entities mentioned by a speaker, etc., while in some embodiments, a server or other computing system may access one or more third party services provided by cloud service providers for machine learning and/or NLP. In some embodiments, a combination of locally-executed artificial intelligence systems and third party-based systems may be used.

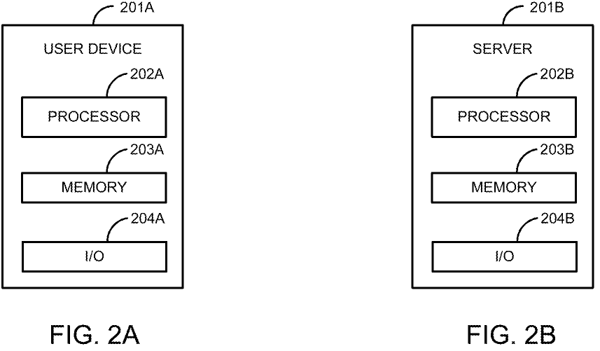

FIGS. 2A and 2B illustrate components of an exemplary user device 201A and server 201B for use in certain embodiments as described herein. In some embodiments, a user device 201A may comprise a processor 202A, memory 203A, and input/output devices 204A. Similarly, a server 201B may comprise a processor 202B, memory 203B, and input/output devices 204B.

A processor 202A, 202B may comprise a processor or microprocessor. As used herein, the word processor may refer to a plurality of processors and/or microprocessors operating together. Processors 202A, 202B may be capable of executing software and performing steps of methods as described herein. For example, a processor 202A, 202B may be configured to display user interfaces on a display of a computer device. Memory 203A, 203B of a user device 201A, 201B may comprise memory, data storage, or other non-transitory storage device configured with instructions for the operation of the processor 202A, 202B to perform steps described herein. Accordingly, processes may be embodied as machine-readable and machine-executable code for execution by a processor to perform the steps herein and, optionally, other processing tasks. Input/output devices 204A, 204B may comprise, but should not be considered as limited to, touchscreens, keyboards, mice, microphones, cameras, display devices, network cards, etc.

Illustratively, the user communication devices 101A, 101B, the communication applications, the displays, the application(s), are stored-program-controlled entities, such as a computer or microprocessor, which performs the methods and the processes described herein by executing program instructions stored in a computer readable storage medium, such as a memory (i.e., a computer memory, a hard disk, and/or the like). Although the methods described herein may be shown in a specific order, one of skill in the art would recognize that the steps of systems and methods described herein may be implemented in different orders and/or be implemented in a multi-threaded environment. Moreover, various steps may be omitted or added based on implementation.

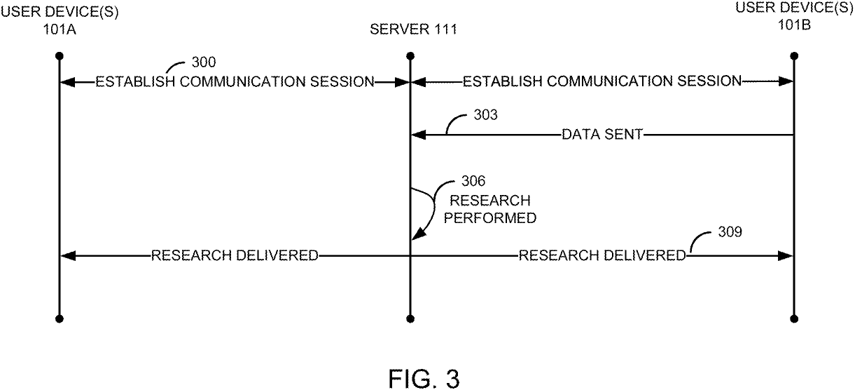

FIG. 3 is a flow diagram of a process using a research assistant application to enable users of user devices 101A, 101B to be presented with data responsive to a spoken or written conversation via use of a research assistant application. Each user of the plurality of users may operate a separate user device 101A, 101B, and may each be separately enabled to view research data generated by the same or a separate research assistant application. For example, a research assistant application may be an application executed by a processor of each user device 101A, 101B participating in the communication session or may be an application executed by a server 111 hosting a communication session. In the embodiment illustrated in FIG. 3, the research assistant application is a process executed by the server 111.

The process illustrated in FIG. 3 starts when a communication session is established at 300. A communication session may be established for example when one user of a user device uses a communication application, such as Avaya Spaces, to begin a communication session with one or more other users of user devices. The users participating in the communication session may be considered as being participants of the communication session.

Once a communication session is established, user devices may be free to join the communication session to communicate with other user devices participating in the communication session. For example, a user device 101B may join the communication session and transmit audio, video, and/or text data via the communication session to other devices participating in the communication session.

During or after a communication session, a user device 101B may be configured to transmit data to the server 111 at 303. Data transmitted by a user device 101B may comprise, for example, audio data, such as the voice of a user using the user device 101B, text data, such as written messages typed by the user using the user device 101B, visual data, such as images, for example PowerPoint slideshows, or a video stream showing the user. In the example illustrated in FIG. 3, the server 111 executes a research assistant application. When a user device 101B, or any other user device participating in the communication session, transmits data via the communication session, the research assistant application may receive the data, perform an analysis of the data, and generate research data based on the data at 306, and provide the research data via the communication session in a user-friendly manner in response to the data at 309.

Performing analysis may comprise the research assistant application analyzing data, such as audio, text, image, video, or other types of data, generated by users during a communication session, detecting keywords, phrases, topics, entities, etc. which may indicate a current topic of conversation, identifying the current topic of conversation, performing research based on the current topic of conversation, determining a quality of the research results, and displaying one or more of the research results.

In some embodiments, performing analysis may comprise the research assistant application analyzing data of a plurality of types. For example, in addition to or alternatively to audio from an audio/video communication session, the research assistant application may be configured to analyze text from a text conversation occurring within the communication session, data shared by one or more users during the communication session, or other data. For example, any documents, files, presentations, images, etc., which may be shared by a user, such as by sharing a screen or sending a document in a text chat window, may be used as an input dataset by the research assistant application.

Analysis performed by a research assistant application executed by a user device 101A, 101B or server 111 may be performed automatically. For example, a neural network such as a convolutional neural network or other type of artificial intelligence system may be used. In some embodiments, analysis performed by a research assistant application may comprise leveraging third party artificial intelligence service providers hosted in a public cloud.

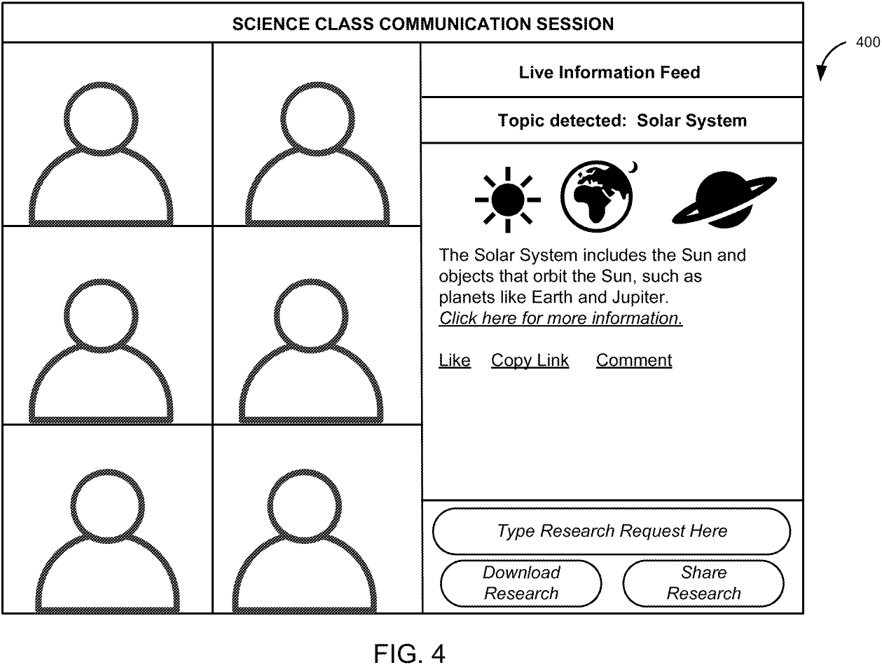

As research data generated during a communication session by a research assistant application executed by a user device or a server, the results of the research data may be displayed in a user interface 400 such as illustrated in FIG. 4.

The research assistant application user interface 400 may be displayed on a user device participating in a communication session during the communication session. The user interface 400 may comprise in some embodiments, a window or windows displaying images of users participating in the communication session. A window may display an image of a user of the user device displaying the user interface 400. The images of the users participating in the communication session may be captured by image capture devices such as webcams operated by user devices operated by each user in the communication session. In addition to image data, each user device may also be configured to transmit audio data via the communication session. For example, each user device may be equipped with or in communication with a microphone. Image and audio data transmitted through the communication session may be shared with users participating in the communication session via a user interface 400 such as illustrated in FIG. 4. It should be appreciated that while in the example illustrations of user interfaces described in relation to the Figures presented herein, the systems and methods disclosed herein may be implemented without displaying or capturing images of users. For example, in some embodiments, only a voice of one or more users and/or images or documents shared by one or more users in a meeting may be used as an input to the system and no images of the user may be required.

In some embodiments, a user interface 400 may also comprise a live information feed panel or window. The live information feed panel may be configured to display results from a research assistant application operated in relation to the communication session.

For example, as illustrated in FIG. 4, the research assistant application may be an application executed by a server hosting the communication session or one and/or more of the user devices participating in the communication session. As data, in the form of audio, text, and/or images, shared by one or more of the users arrives in the communication session, the research assistant application may process the data, as described herein, to identify a topic of discussion. After a topic of discussion is identified, the research assistant application may be configured to perform research relating to the topic. Results of the research may be scored for significance or relevance. For example, a score may be assigned to results and a threshold score value may be used to determine whether a particular result should be delivered in the communication session. If the research assistant application determines a particular result should be delivered, the research assistant application may generate a result message and deliver the result message comprising data relating to the particular result to the live information feed panel.

Each result displayed in the live information feed panel may be displayed in the form of an entry comprising image, video, and/or text. A hyperlink, or other type of user-interactive element, may be displayed with each entry. The hyperlink, or other element, may be configured to enable a user to view a source of the data in the entry, view other results such as results not meeting a score threshold, or to otherwise view data which may be relevant to the discussion.

In some embodiments, generating a research result may comprise identifying research data from one or more data sources and generating an abstract of the research data. The abstract of the research data may be, for example, a sentence or a few words summarizing the research data. The abstract may also or alternatively include one or more images which may be identified as summarizing the research data. The abstract may be presented with a link or other means of enabling a user to view the source or sources of the data to view data in addition to that of the abstract data. In this way, an abstract of the information may be created such that users participating in a communication session are enabled to quickly get a sense of the more detailed information available if the users require the additional data.

Each entry may also be displayed with links enabling users to add a like to the entry, copy a link to the entry, comment on the entry, or otherwise interact with the entry. For example, a user participating in the communication session may like a comment GUI button, type a comment, and the comment may be shared with other users participating in the communication session. Users can also interact with the live information feed panel by typing or speaking a request for research. In some embodiments, users may be enabled to search from within research results generated by the research assistant application. For example, during a meeting a user may desire to view search results from earlier in the meeting. The user may be enabled by the user interface to input a search term and view any research items generated by the research assistant application matching the search term. Users can also download results from the live information feed, and/or share the results. For example, by clicking a download results GUI button, a user may be presented with a PDF or other filetype document containing each of the results of research shared in the live information feed during the communication session.

By clicking or otherwise selecting a “like” GUI button in a live feed window, a user provides feedback to the research assistant application that the provided research results are useful. In some embodiments, the research assistant application may be enabled to use likes and other feedback provided by users as training data to train the artificial intelligence engine used to generate research results. In this way, more relevant information may be provided for future live information feeds.

Upon receiving data generated during a communication session, the research assistant application may process the data. Processing the data generated during a communication session may comprise, in some embodiments, inputting audio data, raw or processed, or a text version of the data, such as a transcript, into a natural language processing (NLP) system or other type of language analysis. Using NLP or another analysis system, the research assistant application may interpret the data and based on the interpretation of the data, generate a search prompt. A search prompt may comprise, in some embodiments, a text string including search terms along with Boolean operators. A search prompt may be generated based on a detection of a topic or an entity within data generated during a communication session. In some embodiments, a topic may be detected but a search prompt may not be generated until the research assistant application determines the topic meets a threshold of significance. For example, the research assistant application may determine a topic meets a threshold of significance if the topic has been discussed for more than one minute.

Upon receiving data and determining a search prompt should be created, the research assistant application may also determine one or more databases or files to search when performing research. For example, in some embodiments, a research assistant application may search only public data resources, such as by using a search engine on the Internet. In some embodiments, the research assistant application may determine a private database should be searched. Searching a private database may be useful for presenting research data during a private communication session between employees of a business entity. For example, the research assistant application may be configured to search for data existing in any resource which is accessible to each of the participants of the communication session. In such an embodiment, the research assistant application may be configured to determine an access level of each participant. In some embodiments, user configurable settings may be used to adjust the databases which the research assistant application should use in performing the research.

In some embodiments, the determination as to which databases, Internet locations, or files the research assistant application may search when performing research may be based on user-configurable settings. The sources may vary based on meeting settings or users participating in the communication session. In some embodiments, the research assistant application may determine which sources are available to at least one or in some cases all participants before searching such sources. In this way, the research assistant application may avoid disclosing material to which one or more participants should not have access.

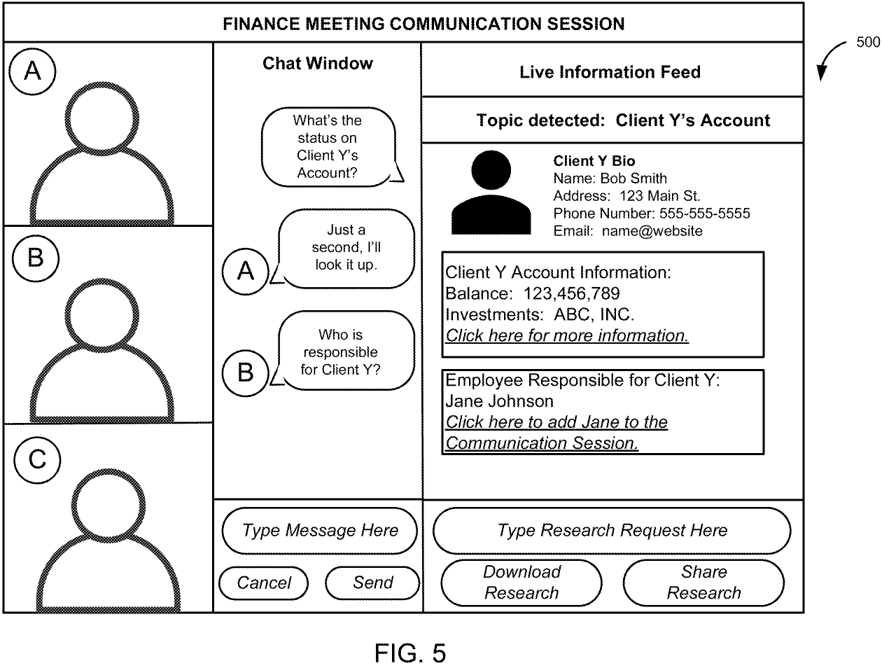

As illustrated in FIG. 5, users participating in a communication session may be enabled to communicate using text, audio, and/or video during a communication session. In such an embodiment, the research assistant application may be configured to analyzed information shared via text in addition to or alternative to analyzing audio and/or image data. For example, the live information feed may display results based on topics of discussion detected within a chat window of a user interface 500.

The research assistant application may be configured to process text, such as messages sent during the communication session and extract important information. In this way, the research assistant application may be configured to present, via the live information feed, research results relating to topics discussed via text.

As described herein, research results may comprise data from public databases or resources, such as websites on the Internet, and/or private databases, such as servers managed by a business entity. In the example illustrated in FIG. 5, a corporate meeting is occurring during a communication session. Each user is an employee of the corporation. A first user asks about a particular client via a chat window. The research assistant application is configured to detect the conversation relates to the particular client, perform research by searching through both public and private databases, and present results of the research in the form of entries in the live information feed panel. Hyperlinks in an entry may be configured to enable a user to view more information from a source, for example, the user may be presented with a file explorer window containing files internal to the corporation relating to the topic.

Research results may also comprise identifications of users. For example, a topic may relate to a particular matter for which a particular user is responsible. A research assistant application may be configured to identify such a particular user and present any contact information which may be found relating to the particular user. In some embodiments, a user-interactive GUI element, such as a hyperlink, may be displayed which may enable a user to interact with the particular user. For example, the GUI element may enable the particular user to be added to the communication session as a new participant.

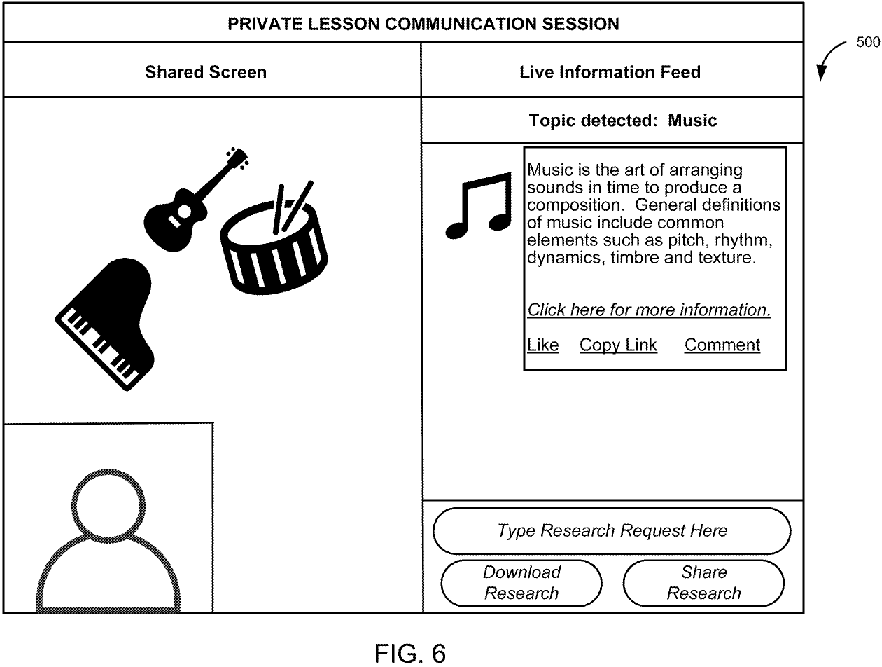

As illustrated by the user interface 600 of FIG. 6, a user of a user device may be capable of sharing a screen or other content during a communication session. For example, a communication session user interface 600 may comprise a view of users participating in the communication session, a shared screen or shared content window enabling users to view visual data shared by a user during a communication session, and a research assistant application window enabling users participating in the communication session to view research assistant application results during the communication session. Visual data shared during a communication session, such as a shared screen of a user device may be analyzed by a. research assistant application. For example, images shared by a user may be input into a convolutional neural network or other type of artificial intelligence system which may be configured to output a topic based on an input image. In some embodiments, a still image taken from a video stream shared by a user may be used as an input into an artificial intelligence system. Based on the output of the artificial intelligence system, the research assistant application may display an identification of the identified topic along with one or more entries comprising research results relating to the topic. For example, as illustrated in FIG. 6, the research assistant application may be configured to analyze an image comprising a piano, a guitar, and a drum, and determine the topic is music. Audio data shared by a user can also be analyzed by a research assistant application. For example, if a user shares a clip of a song, the research assistant application may be capable of identifying the shared song and presenting research data entries identifying the shared song and information about the shared song.

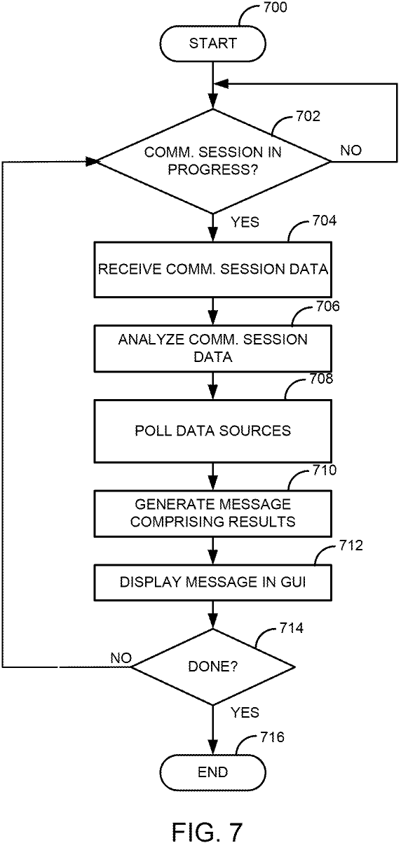

As illustrated in FIG. 7, a process of executing a research assistant application may be performed by a processor of a user device, a processor of another computing device, or a combination of processors of a number of devices. The process of FIG. 7 may begin at step 700 in which a communication session between two or more user devices has been established or has already occurred. The communication session may be, for example, in the form of a message group using a text communication application, an online discussion such as an Internet forum or a text instant messaging application, a live meeting using a conferencing application such as Avaya Spaces, etc. At step 702, a processor may wait for the communication session to begin. Once the communication session has begun and is in progress at step 702, the research assistant application may begin waiting for data to be shared or otherwise transmitted during the communication session.

At 704, the research assistant application may monitor data sent between user devices participating in the communication session. For example, during a communication session, the research assistant may monitor audio and video data transmitted through the communication session by participating user devices. In some embodiments, the research assistant application may monitor text sent by user devices in a chat window of the communication session and/or audio, video, or image data shared by a user device, such as through a shared screen.

The data monitored by the research assistant application may be adjusted based on user-configurable settings. For example, a user such as the user having organized the communication session may be enabled to interact with the research assistant application to set a number of options. Options may in some embodiments include the types of data which should be monitored. For example, a user may restrict the research analyst to monitoring only audio or only data from one particular users during the communication session. It should be appreciated that any number of user settings may be implemented to customize the performance of the research assistant application in a number of ways.

Upon receiving data generated during a communication session, the research assistant application may process the data. Processing the data generated during a communication session may comprise, in some embodiments, inputting audio data, raw or processed, or a text version of the data, such as a transcript, into a natural language processing (NLP) system or other type of language analysis. Using NLP or another analysis system, the research assistant application may interpret the data and based on the interpretation of the data, generate a search prompt. A search prompt may comprise, in some embodiments, a text string including search terms along with Boolean operators. A search prompt may be generated based on a detection of a topic or an entity within data generated during a communication session. In some embodiments, a topic may be detected but a search prompt may not be generated until the research assistant application determines the topic meets a threshold of significance. For example, the research assistant application may determine a topic meets a threshold of significance if the topic has been discussed for more than one minute.

At 706, the research assistant application may analyze the data received via the communication session to determine one or more topics. Determining topics based on data received via the communication session may comprise using NLP, a convolutional neural network, any type of machine learning, deep learning, artificial intelligence system, etc., or some combination thereof, to interpret spoken word, text, images, etc. In some embodiments, the research assistant application may be configured to determine a possible topic based on communication session data and for each possible topic, determine a degree of confidence. The degree of confidence may be a score, for example from one to one hundred, and may represent a likelihood the possible topic is a topic which is relevant to the conversation occurring in the communication session. A degree of confidence may in some embodiments be based in whole or in part on a minimum number of mentions of the topic.

In some embodiments, possible topics may be determined at particular intervals. For example, the research assistant application may be configured to analyze communication session data over a particular time period, such as three minutes. After the time period elapses, the research assistant application may determine a topic which is most relevant or is associated with a highest degree of confidence during the time period. In some embodiments, multiple topics may be selected for a particular time period. For example, a threshold score level may be used and each possible topic exceeding the threshold score level on a basis of degree of confidence may be used as a search factor.

At 708, the research assistant application may determine search factors associated with the one or more topics identified based on the communication session data analyzed in step 706, discussed above. Search factors, in some embodiments, may simply be a word or phrase describing the topic identified based on the analysis of step 706.

In addition to identifying search factors for each topic, the research assistant application may be configured to identify one or more data sources which should be searched to generate research data. Upon receiving data and determining a search prompt should be created, the research assistant application may also determine one or more databases or files to search when performing research. For example, in some embodiments, a research assistant application may search only public data resources, such as by using a search engine on the Internet. In some embodiments, the research assistant application may determine a private database should be searched. Searching a private database may be useful for presenting research data during a private communication session between employees of a business entity. For example, the research assistant application may be configured to search for data existing in any resource which is accessible to each of the participants of the communication session. In such an embodiment, the research assistant application may be configured to determine an access level of each participant. In some embodiments, user configurable settings may be used to adjust the databases which the research assistant application should use in performing the research.

In some embodiments, the data sources may be identified based on user settings. For example, a user may explicitly instruct the research assistant application to search only certain data sources, such as via an Internet search using, for example, Wikipedia, etc., or via a data lookup in a file location on a drive accessible by one or more of the participants, such as using a Windows search.

In some embodiments, the determination as to which databases, Internet locations, or files the research assistant application may search when performing research may be based on user-configurable settings. The sources may vary based on meeting settings or users participating in the communication session. In some embodiments, the research assistant application may determine which sources are available to at least one or in some cases all participants before searching such sources. In this way, the research assistant application may avoid disclosing material to which one or more participants should not have access.

Data sources may comprise, for example, one or more of frequently updated information in one or more project management tools or repositories, a management portal for an organization, internal forums for an organization, statistical data available in public domain, trending news in social media, online forums, news websites, etc., factual details available for example in Wikipedia, analytical and graphical data available in public domain or organizational tools and repositories, and/or any combination thereof.

At 708, the data sources may be polled based on the search terms identified based on the topics. In some embodiments, polling the data sources may comprise using an artificial intelligence system trained to identify and copy text directly related to keywords and phrases from data locations, to identify and copy images associated with keywords and phrases, from data locations, etc. By polling data sources, the research assistant application may be configured to generate a set of search results. A set of search results may in some embodiments comprise text, video, and/or image data relating to one or more search terms.

At 710, after generating search result in 708, the method 700 may comprise generating one or more messages comprising results of the research. Generating messages may comprise editing text to be displayed in a user friendly manner, such as by using NLP or an artificial intelligence system. Messages may comprise text and/or image data. Generating a message may comprise selecting an image and/or a text string from the research results and building a message data packet comprising the selected image and/or text string. In some embodiments, a message data packet may be in a form configured to be displayed within a graphical user interface of an information feed panel as illustrated in relation to FIGS. 4-6.

At 723, the message may be displayed in the user interface of the communication session. As described herein, messages may be displayed along with hyperlinks and/or other types of user interactive graphical user interface elements which may enable users to select research result messages, add a like or dislike to the messages, add a comment to the messages, etc.

At 714, the method 700 may comprise determining whether the research process is complete and whether the method 700 should end. If the research process should continue, the method 700 may comprise returning to 702 and determining whether the same or a new communication session is active. If the research process should not continue, the method 700 may end at 716.

Embodiments include a computer-implemented method comprising: receiving, with a processor, data from a communication session; analyzing, with the processor, the data to detect one or more entities; polling, with the processor, one or more data sources to generate a data set based on the detected entities; generating, with the processor, a message comprising the data set; and displaying, with the processor, the message on a user interface.

Aspects of the above method include wherein the data is received from a plurality of sources.

Aspects of the above method include wherein the message is configured to be displayed by a plurality of user devices participating in the communication session.

Aspects of the above method include wherein the message is displayed in a live feed.

Aspects of the above method include wherein the message comprises a hyperlink to a source of the data set.

Aspects of the above method include wherein the data set comprises one or more of an image, a video, a URL of a website.

Aspects of the above method include wherein the data comprises audio received from a user device participating in the communication session, and wherein the message is displayed on the user device.

Aspects of the above method include wherein the data set comprises data from a public data source and data from a private data source.

Aspects of the above method include wherein the data set comprises a URL of a website, and wherein the message comprises a title of the website and a snippet of text from the website, wherein the snippet of text from the website is selected by the processor based on the detected entities.

Aspects of the above method include wherein the message is displayed in a window of the user interface proximate to a window comprising a display of a video of participants in the communication session.

Embodiments include a device comprising: a processor; and a computer-readable storage medium storing computer-readable instructions which, when executed by the processor, cause the processor to execute a method, the method comprising: receiving data from a communication session; analyzing the data to detect one or more entities; polling one or more data sources to generate a data set based on the detected entities; generating a message comprising the data set; and displaying the message on a user interface.

Aspects of the above device include wherein the data is received from a plurality of sources.

Aspects of the above device include wherein the message is configured to be displayed by a plurality of user devices participating in the communication session.

Aspects of the above device include wherein the message is displayed in a live feed.

Aspects of the above device include wherein the message comprises a hyperlink to a source of the data set.

Aspects of the above device include wherein the data set comprises one or more of an image, a video, a URL of a website.

Aspects of the above device include wherein the data comprises audio received from a user device participating in the communication session, and wherein the message is displayed on the user device.

Aspects of the above device include wherein the data set comprises data from a public data source and data from a private data source.

Aspects of the above device include wherein the data set comprises a URL of a website, and wherein the message comprises a title of the website and a snippet of text from the website, wherein the snippet of text from the website is selected by the processor based on the detected entities.

Aspects of the above device include wherein the message is displayed in a window of the user interface proximate to a window comprising a display of a video of participants in the communication session.

Embodiments include a computer program product comprising: a non-transitory computer-readable storage medium having computer-readable program code embodied therewith, the computer-readable program code configured, when executed by a processor, to execute a method, the method comprising: receiving data from a communication session; analyzing the data to detect one or more entities; polling one or more data sources to generate a data set based on the detected entities; generating a message comprising the data set; and displaying the message on a user interface.

Aspects of the above computer program product include wherein the data is received from a plurality of sources.

Aspects of the above computer program product include wherein the message is configured to be displayed by a plurality of user devices participating in the communication session.

Aspects of the above computer program product include wherein the message is displayed in a live feed.

Aspects of the above computer program product include wherein the message comprises a hyperlink to a source of the data set.

Aspects of the above computer program product include wherein the data set comprises one or more of an image, a video, a URL of a website.

Aspects of the above computer program product include wherein the data comprises audio received from a user device participating in the communication session, and wherein the message is displayed on the user device.

Aspects of the above computer program product include wherein the data set comprises data from a public data source and data from a private data source.

Aspects of the above computer program product include wherein the data set comprises a URL of a website, and wherein the message comprises a title of the website and a snippet of text from the website, wherein the snippet of text from the website is selected by the processor based on the detected entities.

Aspects of the above computer program product include wherein the message is displayed in a window of the user interface proximate to a window comprising a display of a video of participants in the communication session.

Examples of the processors as described herein may include, but are not limited to, at least one of Qualcomm® Snapdragon® 800, 810, 820, Qualcomm® Snapdragon® 610 and 615 with 4G LTE Integration and 64-bit computing, Apple® A7 processor with 64-bit architecture, Apple® M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, ARM® Cortex-A and ARM926EJ-S™ processors, Rockchip RK3399 processor, other industry-equivalent processors, and may perform computational functions using any known or future-developed standard, instruction set, libraries, and/or architecture.

Any of the steps, functions, and operations discussed herein can be performed continuously and automatically.

However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should however be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined in to one or more devices or collocated on a particular node of a distributed network, such as an analog and/or digital telecommunications network, a packet-switch network, or a circuit-switched network. It will be appreciated from the preceding description, and for reasons of computational efficiency, that the components of the system can be arranged at any location within a distributed network of components without affecting the operation of the system. For example, the various components can be located in a switch such as a PBX and media server, gateway, in one or more communications devices, at one or more users’ premises, or some combination thereof. Similarly, one or more functional portions of the system could be distributed between a telecommunications device(s) and an associated computing device.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire and fiber optics, and may take the form of acoustic or light waves, such as those generated during radio-wave and infra-red data communications.

Also, while the flowcharts have been discussed and illustrated in relation to a particular sequence of events, it should be appreciated that changes, additions, and omissions to this sequence can occur without materially affecting the operation of the disclosure.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer, such as an applet, JAVA®, CGI script, or any suitable programming language, as a resource residing on a server or computer workstation, as a routine embedded in a dedicated measurement system, system component, or the like. In some embodiments, multiple programming languages may be used to develop different components of the system. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein, and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, sub combinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease and\or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

1. A computer-implemented method comprising:
receiving, with a processor, data sent from a first user device of a plurality of user devices to one or more other user devices of the plurality of user devices during a communication session;
detecting, with the processor, one or more entities in the received data ;
polling, with the processor, one or more data sources to generate a data set based on the detected one or more entities;
generating, with the processor, a message comprising the data set; and
displaying, with the processor, the message on a user interface in the communication session.

2. The method of claim 1, wherein the data set comprises data from a plurality of data sources.

3. The method of claim 2, further comprising sending the message tothe plurality of user devices .

4. The method of claim 1, wherein the message is displayed in a live feed in the communication session.

5. The method of claim 1, wherein the message comprises a hyperlink to one of the data sources polled to generate the data set.

6. The method of claim 1, wherein the data set comprises one or more of an image, a video, and a URL of a website.

7. The method of claim 1, wherein the data from the communication session comprises one or more of audio, a video, text, and an image received from the first user device , and wherein the message is displayed on the first user device.

8. The method of claim 1, wherein polling one or more data sources comprises polling a public data source and a private data source.

9. The method of claim 1, wherein the data set comprises a URL of a website, and wherein the message comprises a title of the website and a snippet of text from the website, wherein the snippet of text from the website is selected by the processor based on the detected entities.

10. The method of claim 1, wherein the message is displayed in a window of the user interface proximate to a window comprising a display of a video of participants in the communication session.

11. The method of claim 1, wherein displaying the message comprises displaying the message with graphical user interface elements enabling a user to share the message in the communication session.

12. The method of claim 1, wherein detecting the one or more entities comprises inputting the data into a neural network, wherein the neural network is trained to detect the one or more entities.

13. A device comprising:
a processor; and
a computer-readable storage medium storing computer-readable instructions which, when executed by the processor, cause the processor to execute a method, the method comprising:
receiving data sent from a first user device of a plurality of user devices to one or more other user devices of the plurality of user devices during a communication session;
detecting one or more entities in the received data ;
polling one or more data sources to generate a data set based on the detected one or more entities;
generating a message comprising the data set; and
displaying the message on a user interface in the communication session.

14. The device of claim 13, wherein the data set comprises data from a plurality of data sources.

15. The device of claim 14, further comprising sending the message to the plurality of user devices .

16. The device of claim 13, wherein the message is displayed in a live feed in the communication session.

17. The device of claim 13, wherein the message comprises a hyperlink to one of the data sources polled to generate the data set.

18. The device of claim 13, wherein the data set comprises one or more of an image, a video, and a URL of a website.

19. The device of claim 13, wherein the data from the communication session comprises one or more of audio, a video, text, and an image received from the first user device , and wherein the message is displayed on the first user device.

20. A computer program product comprising:
a non-transitory computer-readable storage medium having computer-readable program code embodied therewith, the computer-readable program code configured, when executed by a processor, to execute a method, the method comprising:
receiving data sent from a first user device of a plurality of user devices to one or more other user devices of the plurality of user devices during a communication session;
detecting one or more entities in the data from the communication session;
polling one or more data sources to generate a data set based on the detected one or more entities;
generating a message comprising the data set; and
displaying the message on a user interface in the communication session.
